(19) United States
(12) Patent Application Publication
(10) Pub. No.: US 2008/0251981 A1
(43) Pub. Date: Oct. 16, 2008

(54) Torsional Vibration Damper

(75) Inventors: Olaf Greshake, Stuttgart (DE); Markus Becker, Dortmund (DE)

Correspondence Address: BAKER & DANIELS LLP;111 E. WAYNE STREET, SUITE 800, FORT WAYNE, IN, 46802, US

(73) Assignee: VOITH TURBO GMBH & CO. KG, Heidenheim (DE)

(21) Appl. No.: 12/088,714

(22) PCT Filed: Oct. 5, 2006
(86) PCT No.: PCT/EP06/09625

§ 371 Date: Jul. 1, 2008

(30) Foreign Application Priority Data
Oct. 5, 2005 (DE) 10 2005 047 802.6

(51) Int. Cl. F16F 15/12

(52) U.S. Cl. 267/140.5; 73/865.9

(57) ABSTRACT

The invention relates to a torsional vibration damper with a flexible coupling (2), comprising at least one first coupling element (3) which can be connected to a driving element, at least one second coupling element (4) which can be connected to a power take-off in a rotationally fixed manner, said elements being at least indirectly coupled to each other via spring and/or damping coupling means (5). The damper also comprises a device (6) for detecting at least one variable that is at least indirectly characteristic of the mode of functioning and/or operation of the flexible coupling. The invention is characterized by the following features: the device (6) for detecting at least one variable that is at least indirectly characteristic of the mode of functioning is integrated into the flexible coupling (2); the device for detecting at least one variable that is at least indirectly characteristic of the mode of operation of the flexible coupling comprises means (15) for acquiring the operational characteristics and a permanently mounted interface (7), comprising means (8) for reading out the variables that are at least indirectly characteristic of the mode of operation of the flexible coupling (2).

The invention relates to a torsional vibration damper with a flexible coupling, in which a system for the determination of function and/operating data for the flexible coupling is integrated.

Torsional vibration dampers with flexible couplings are known in a multitude of embodiments. The flexible couplings comprise a first coupling element which can be connected to a driving element, a second coupling element which can be connected to a power take-off, wherein both coupling elements are connected to one another via means for spring and/or damping coupling. The coupling takes place in the process in such a way that torque can be transferred via the means for spring and/or damping coupling and further first and second coupling elements are twistable in limited extent with relation to one another in circumferential direction. The means for the spring and/or damping coupling can be designed in the process in the simplest case as flexible elements, for example in the form of spring units or an elastomer. More complex systems are characterized by the integration of hydraulic damping components. In the process the task of such a flexible coupling consists in the reduction of the torsional vibrations generated by a drive engine to a measure endurable for the drive train. However this requires the operability of the flexible coupling. For verification of the effectiveness for this reason so-called torsional vibration measurements are performed. For this purpose both the angle of twist, angular accelerations or torques are measured, wherein one obtains the best statements from a measurement of torque. For this purpose the components of the flexible coupling coupled to the drive and the output are assigned to means for the detection of the speed, in particular in the form of speed sensors, and the corresponding variables are determined from the difference. In analogy a measurement of the angle of twist also takes place when the rigidity of the twisted component of the drive train is known.

An additionally known measure is the application of a component with known rigidity, for example the pipe of a propeller shaft made of steel in the drive train between drive engine and power consumer with strain gauge. Since the components coming into question for connection of the strain gauge however as a rule do not come supplied with the flexible coupling, the torsional vibration measurement must be performed on a component not belonging to the flexible coupling. However, this is a considerable disadvantage for suppliers of flexible couplings, who are frequently responsible for the torsional vibration capability of the entire drive train, since one must resort to the components of the drive train not belonging to the scope of supply. In addition the application of such a component is expensive and no longer usable after the measurement. The measuring signals must be sent with the help of a telemetry system from a rotating component, for which purpose additional devices must be brought on site and arranged. In particular this method is characterized by a considerable additional expenditure so that such a torsional vibration measurement is too expensive for broad application.

Another possibility is the recording of the primary and secondary parts of the flexible coupling. From these signals in the case of the known coupling rigidity the torques and torsional vibrations can be determined by means of mathematical post processing. For example for this purpose the screw heads of the flange joints of the flexible coupling are scanned. However, one significant disadvantage of this method consists in the fact that the required sensors must be mounted by a person skilled in the art in a differently designed environment with each measurement. In addition in the case of this method various restrictions, in particular with regard to the frequency and angular resolution, must be tolerated. Here too the described method is characterized by a considerable additional expenditure, which is not justifiable for many applications.

The invention is therefore based on the object of developing a torsional vibration damper with a system for recording of the variables describing the mode of operation and/or mode of functioning of a flexible coupling integrated into the torsional vibration damper at least indirectly in such a way that the system for one thing can be integrated in the scope of delivery of the manufacturer of the torsional vibration damper or of the flexible coupling and can be limited to only this element and further is characterized by a low expenditure of design, control engineering and cost.

The solution in accordance with the invention is characterized by the features of claim 1. Advantageous embodiments are described in the dependent claims.

The system provided in the torsional vibration damper for the detection of operation and/or function data for a flexible coupling, comprising at least one first coupling element which can be connected to a driving element, a second coupling element which can be connected to a power take-off in rotationally fixed manner, said elements being at least indirectly connected to each other via spring or damping coupling means, comprises a device for detecting at least one variable that is at least indirectly characteristic of the mode of functioning and/or operation of the flexible coupling. In accordance with the invention the device for detecting at least one variable that is at least indirectly characteristic of the mode of operation of the flexible coupling is integrated in the flexible coupling. This device comprises means for acquiring the operational characteristics and a permanently mounted interface comprising means for reading out the variables that are at least indirectly characteristic of the mode of operation of the flexible coupling.

The torsional vibration damper is hence characterized by the fact that the flexible coupling, in particular highly flexible coupling, itself is equipped with the corresponding sensors and data acquisition. The supplier of such a torsional vibration damper with highly flexible coupling with this does not need to resort to foreign parts in the drive train. The on board data acquisition makes superfluous any additional measuring equipment for carrying out the measurement on site. A coupling equipped with sensors and data acquisition can be installed by the user himself. The coupling starts and ends the measuring autonomously. Also, no measurement technician is required on site.

The measuring technology is built into the coupling with standardized connection elements. As a result it can be taken out after measurement and removal of the coupling and installed into the next coupling. No measurement technician is required for this activity. Due to the recyclability the expensive measuring technology can also be used a number of times.

The means for acquiring the operational characteristics are in the process arranged coaxially to the rotational axis of the flexible coupling. Said means are in the process built symmetrical with regard to the rotational axis R or lie directly on top of the rotational axis R. The means for acquiring the data are sensors. These are in the simplest case are designed as rpm or centrifugal force sensors.

The minimum configuration of the device for detecting at least one variable that is at least indirectly characteristic of the mode of operation of the flexible coupling comprises along with the means for acquiring the operational characteristics also a permanently mounted interface with means for reading out the variable that is at least indirectly characteristic of the mode of operation of the flexible coupling. For this purpose the device comprises a support system on which the means for acquiring the data or the variable that is at least indirectly characteristic of the mode of operation of the flexible coupling are supported. The support system is connected in rotationally fixed manner to the means for spring and/or damping coupling and one of the coupling elements—first or second coupling element. The support system itself can in the process be designed in various different ways. Preferably said support system comprises a bell-shaped housing part which surrounds the means for acquiring the variables that are at least indirectly characteristic of the mode of operation of the flexible coupling and a disk-shaped element which can be combined with the bell-shaped housing part into a structural unit by a detachable or undetachable connection and which connects the support system to one of the two coupling elements.

With regard to the design of the means for reading out the variables that are at least indirectly characteristic of the mode of operation of the flexible coupling there are a plethora of possibilities. In the simplest case the interface comprises for this purpose a connecting device which can be coupled to an external read-out device via a line connection.

In accordance with an especially advantageous design the device for detecting at least one variable that is at least indirectly characteristic of the mode of operation of the flexible coupling comprises means for data transmission. The design of the means for data transmission depends in the process on the manner of data transmission and on the desired and required time. The means for data transmission are in the process in the simplest case a component of the interface. They can be based on different systems. In the process in principle a distinction is made between wireless data transmission and data transmission via connecting lines. The means for data transmission comprise in the process at least one transmission device. Via said sending device an establishment of the connection can take place either continuously or when required. Preferably these means comprise however also at least one receiving device, via which a connection establishment is possible when required. Under a further, especially advantageous aspect of the invention the functions of the send and receive device are for the creation of a component with the lowest possible installation space requirements and a high degree of standardization combined in one structural unit, said unit preferably being designed as a radio communications device. Other possibilities of data transmission are based on the use of ultrasound signals or infrared signals. The sender and perhaps also the receiving devices are to be designed accordingly.

Regarding the initiation of the establishment of a connection a number of possibilities exist. Conceivable are, as already stated

a) a continuous connection or

b) a randomly adjustable connection and/or

c) a forced establishment of the connection in the case of necessary expectation

Preferably the possibilities named under b) and c) are used. In case a) an automatic data acquisition takes place. The data transmission takes place bi-directionally or quasi bi-directionally.

In the latter named case the establishment takes place in the presence of at least one of the following named states:
the flexible coupling requires maintenance, for example after the expiration of a specified time interval
the transmission of operational characteristics takes place intermittently, arbitrarily or in predefined time intervals
detection of critical operating states of the flexible coupling beforehand through the changing of specified quantities characteristic of the mode of operation or functioning of the flexible coupling
in the exceeding or falling below component-specific threshold values, for example a specified number of operational cycles etc.

In case b) an establishment of the connection is for example conceivable in the case of
desired updating of a control software to be performed for a control device integrated in the flexible coupling
intermittent querying of the data characterizing the mode of functioning of the flexible coupling by the manufacturer or other authorized persons
retrieval of the data stored in the control device integrated in the flexible coupling.

Depending on the evaluation method and performance of the evaluation of the operational characteristics various modifications are distinguished. In the process for example the cruise control system can act as a control and/or evaluation system, said cruise control system being provided in the vehicle in which the flexible coupling is integrated. Also conceivable however are external evaluation and/or control systems which for example are operated by the manufacturer or a maintenance service and to which the corresponding data can be made available.

In accordance with an especially advantageous further development the device for detecting at least one variable that is at least indirectly characteristic of the mode of operation of the flexible coupling comprises a control device which is coupled to the means for data acquisition and which is either coupled to the interface or the interface is integrated into said control device. In accordance with an especially advantageous further development in the process the means for data transmission are also integrated into the control device.

Preferably the control device comprises further at least one of the following named components for additional functions:
an evaluation device
a classification device
a comparison device
calculation devices.

These devices in the process serve the purpose of the pre-evaluation of the detected operational characteristics, wherein the evaluation results then only have to be transmitted. In the end effect this results in a reduction of the required memory space, since only the evaluated data need to be stored and not the entire data stock.

With regard to the arrangement of the individual components of the device for detecting at least one variable that is at least indirectly characteristic of the mode of operation of the flexible coupling a great number of possibilities exist. In the process the individual components can be preferably annular in design and enclose for example the means for data acquisition or the individual components are designed in the form of an annular segment or randomly designed and arranged eccentrically to the rotational axis in such a way that said components are distributed around the perimeter of the means for data acquisition, wherein the arrangement preferably takes place in such a way that the center of gravity of the entire device for the prevention of unbalances nevertheless lies on the rotational axis of the flexible coupling.

The device for detecting at least one variable that is at least indirectly characteristic of the mode of operation of the flexible coupling is detachably connected to the flexible coupling. Preferably said device is built and designed in such a way that it lies on an axial plane with the individual coupling elements of the flexible coupling and in the region of its axial extension. With regard to the reading out of the data the device can remain in the flexible coupling or is removed in its entirety without disturbing the function of the flexible coupling.

The evaluation itself can, as already stated, take place in a device integrated in the flexible coupling, that is in particular in the device for detecting at least one variable that is at least indirectly characteristic of the mode of operation of the flexible coupling or in an external control and/or monitoring system which can be operated by the manufacturer or by a person authorized to perform maintenance.

The torsional vibration damper in accordance with the invention can for example be used in drive trains with speeds of up to 2500 revolutions per minute or even more. Of course other speeds also come into consideration, for example lower speeds up to 100 revolutions per minute or up to 10 revolutions per minute. One application example is the employment of the torsional vibration damper for Diesel engine drives, that is, in the drive train for example of a motor vehicle which has a rear-mounted Diesel engine and is driven by the Diesel engine.

The solution in accordance with the invention will be explained in the following with the help of figures. The figures show the following in particular:

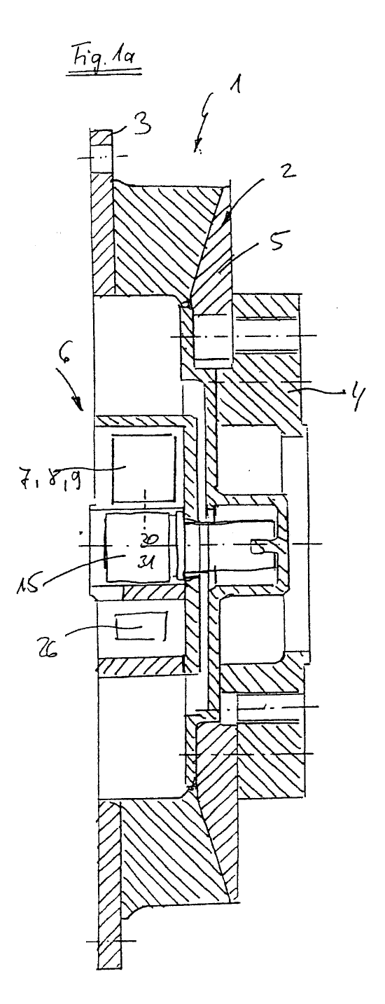

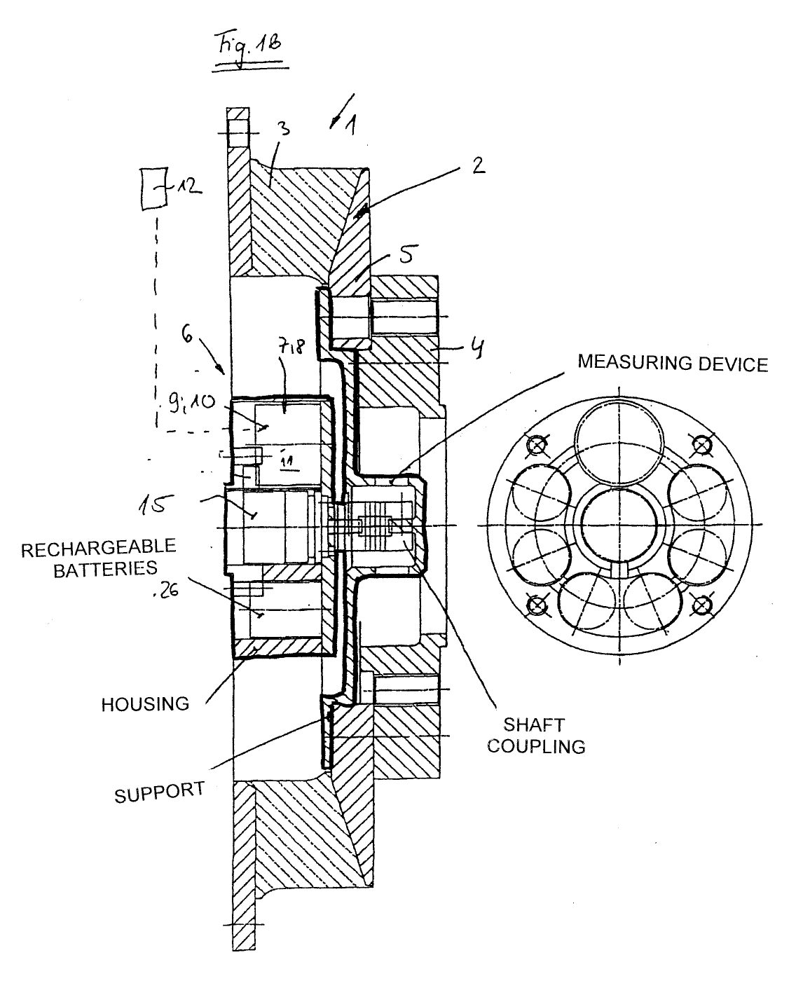

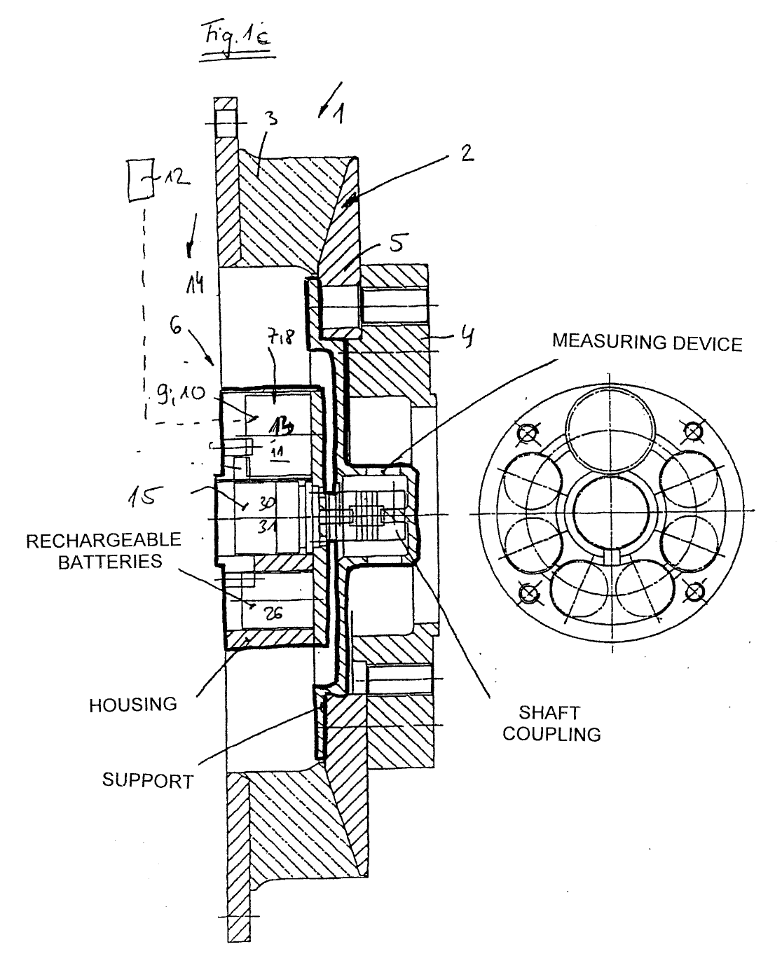

FIGS. 1a through 1e illustrate in schematically greatly simplified representation the basic principle and the basic mode of functioning of a torsional vibration damper designed in accordance with the invention with a system for detecting the mode of operation and/or functioning of the flexible coupling provided for the damping of torsional vibrations and/or axial vibrations;

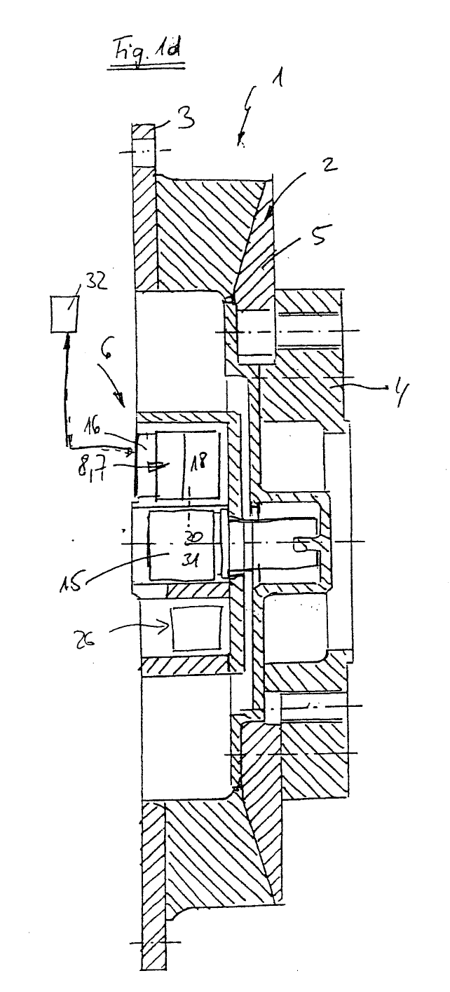

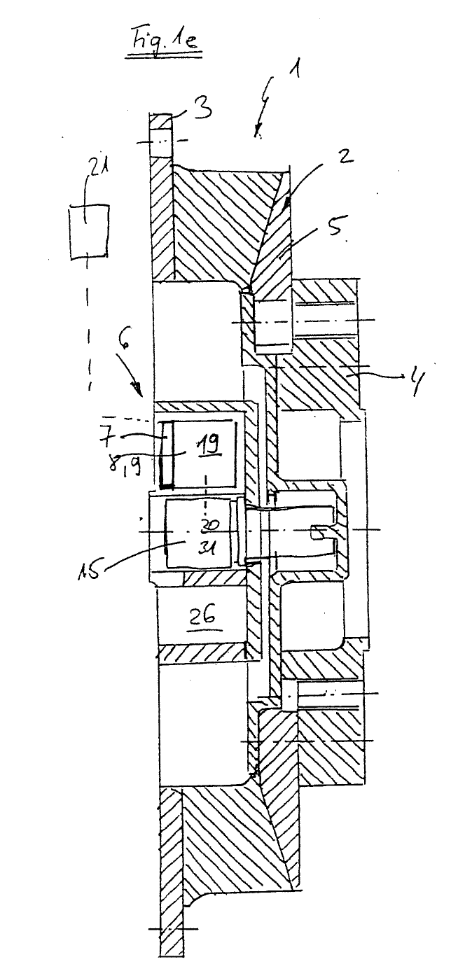

FIG. 2 illustrates a particularly advantageous embodiment of a design in accordance with FIG. 1b by means of an axial section through a flexible coupling;

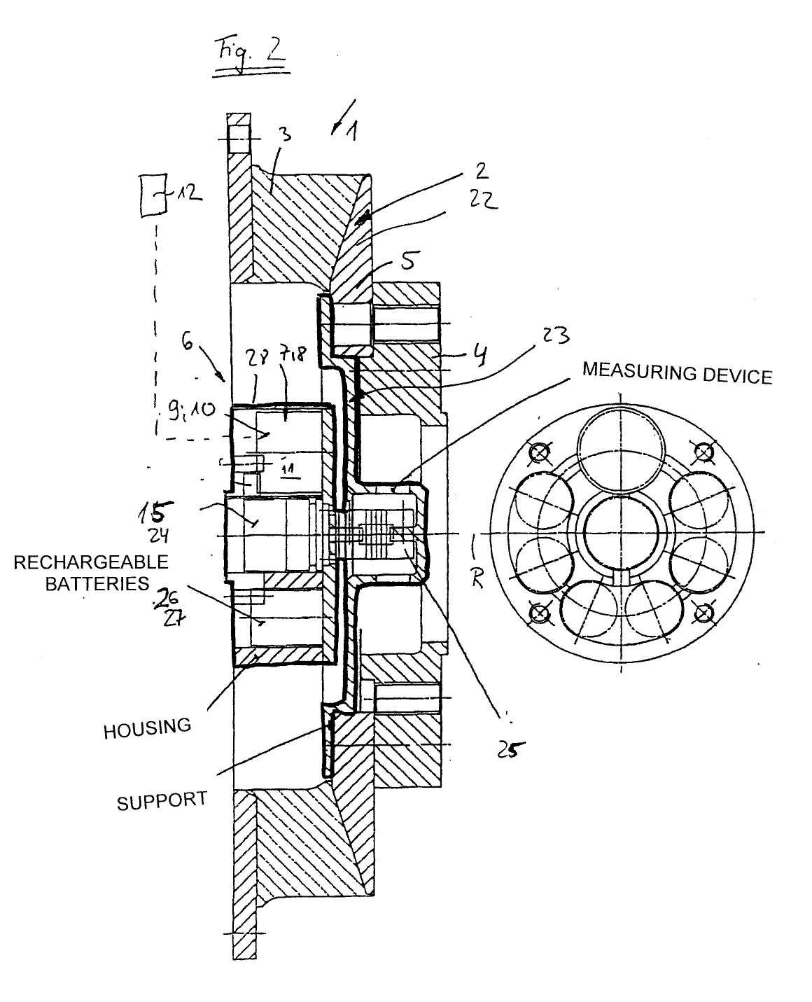

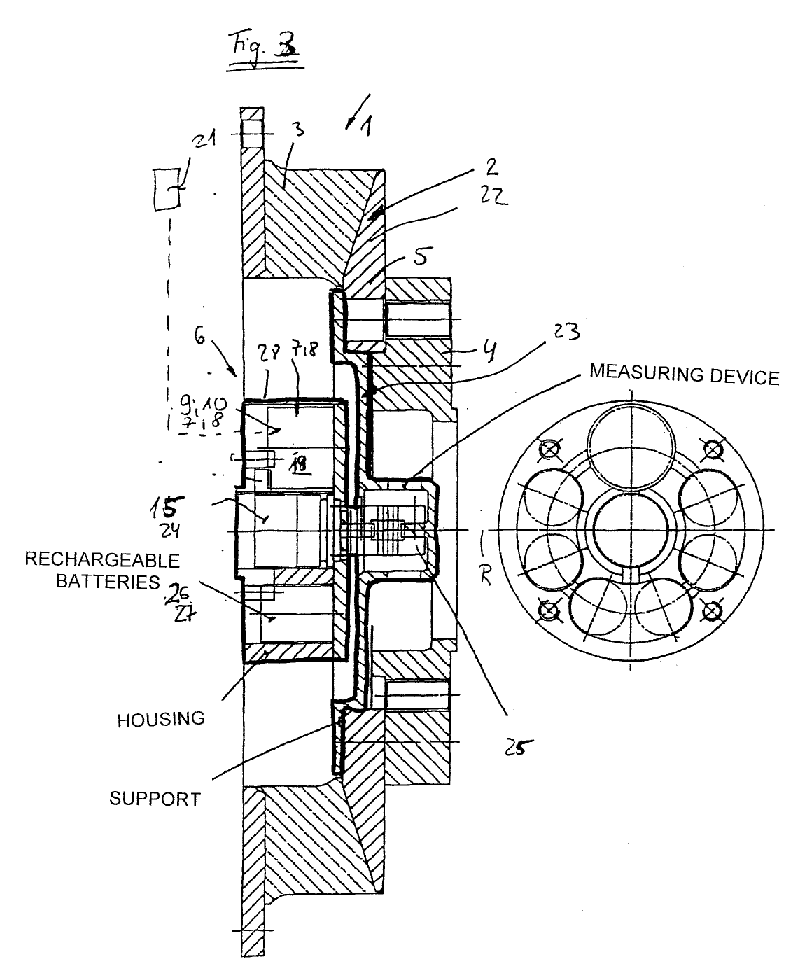

FIG. 3 illustrates a further development in accordance with FIG. 2.

FIG. 1 illustrates in schematically greatly simplified representation the basic structure of a torsional vibration damper designed in accordance with the invention. Said torsional vibration damper comprises a system 1 for determining the operational characteristics for a flexible coupling, comprising a first coupling element 3 that can be connected to a driving element not shown here and a second coupling element 4 which can be connected to a power take-off in a rotationally fixed manner, said elements being at least indirectly coupled to each other via spring and/or damping coupling means 5. The system for determining operational characteristics 1 comprises at least one device 6 for detecting at least one variable that is at least indirectly characteristic of the mode of operation of the flexible coupling. In this connection at least indirectly means that the corresponding variables characterizing the mode of operation are either directly detected or can be determined indirectly via the detection of variables which are in direct functional connection to the variables characterizing the mode of operation and with this determines the variables characterizing the mode of operation, for example through calculation. In accordance with the invention the device 6 for detecting at least one variable that is at least indirectly characteristic of the mode of operation of the flexible coupling is integrated in the flexible coupling 2. The device 6 comprises means 15 for acquiring the variables at least indirectly characterizing the mode of operation of the flexible coupling 2. Said means are designed as sensors or rotary encoders. In accordance with the invention these are arranged coaxially to the rotational axis R

of the flexible coupling 2. The device 6 further comprises an interface 7, comprising means 8 for reading out the variables that are at least indirectly characteristic of the mode of operation of the flexible coupling 2. These means 8 can be designed in various forms. Depending on the performance of the readout process, intermittent, continuous or optional, the device is modified, furthermore the readout data can be transmitted, which takes place via means 9 for data transmission. The data transmission itself can take place continuously or optionally when required, the interface 7 is arranged in dependence thereupon. FIG. 1a in the process illustrates the devices 7, 8, 9 as a black box.

In accordance with FIG. 1b the means 9 for data transmission are designed as means 10 for wireless data transmission. Said means comprise at least one transmission device 11. By wireless data transmission any and all types of wireless data transmission are understood which are free from a fixed cabling between a transmission device and receiving device. Such a transmission takes place preferably as a radio transmission. However transmission via infrared or ultrasound is also conceivable.

In accordance with FIG. 1b the transmission device 11 communicates for example with an external receiving device 12. The data transmission between the transmission device 11 and the receiving device 12 takes place in this case continuously, that is in the case of the presence of the corresponding data in the transmission device 11 from the means 15. In order when required to also be able to activate the transmission device 11, in accordance with FIG. 1c a receiving device 13 is also integrated in the flexible coupling 3, wherein the transmission device 11 and the receiving device 13 with regard to their functions can be combined in one physical unit and preferably are, wherein this takes place in the represented case for example in the form of a telecommunications device 14. In the process by telecommunication a communication between human beings, machines and other systems with the help of telecommunications transmission methods is understood. Forms of communication are speech, text, image and data communication. The device 6 for data acquisition comprises further means 15 for data acquisition and transmission to the means 10 for wireless data transmission. The means 15 for data

acquisition are in the simplest case designed as sensors 30 or as sensors 31, for example in the form of an rpm sensor or centrifugal force sensor. Deciding in the process is the integration of these means in the flexible coupling 2, in particular in the region of the rotational axis R of the flexible coupling 2, as described in detail in FIG. 2.

The design shown in FIG. 1c with integrated transmission device 11 and receiving device 13 communicates in the process for example also with an external receiving device 12. An additional possibility is reproduced in FIG. 1d. Here too the device 6 for detecting at least one variable that is at least indirectly characteristic of the mode of operation of the flexible coupling 2 comprises an interface 7, wherein said interface comprises a connecting device 16. The connecting device 16 is coupled to the means for data acquisition 15, wherein an external readout device 32 can be connected via the connecting device 16. In order to make detection of operational characteristics possible over a longer period of time and to make said detection independent with regard to the reading out of the data, the device 6 for detecting at least one variable that is at least indirectly characteristic of the mode of operation of the flexible coupling 2 in the process comprises along with the means 15 for data acquisition also a memory unit 18 for at least temporary storage of the operational characteristics detected via the means 15. The connecting device 16 is then coupled to the memory unit 18 so that the operational characteristics can be read out here, wherein the memory unit 18 in turn is connected to the means 15.

In accordance with a particularly advantageous design in accordance with FIG. 1e the device 6 for detecting at least one variable that is at least indirectly characteristic of the operational characteristics comprises a control device 19 comprising at least one memory unit 18, wherein said memory unit is coupled to the means 15 for data acquisition. The interface 7 is then a component of the control device 19 in accordance with a particularly advantageous design or can be coupled to said control device 19, wherein the reading out of the data takes place via the interface 7.

The interface 7 in the latter case can be coupled to the control device 19. The coupling takes place preferably electronically, wherein this is realized preferably via means 20

for serial data transmission between the control device 19 and the interface 7. The use of means for parallel data transmission is also conceivable. In this case however a plurality of fixed line connections between the control device 19 and the interface 7 are necessary, which would require a great number of connecting devices 16 at the interface 7. Via the coupling between the control device 19 and the interface 7 the variables characterizing the operational mode of the flexible coupling 2 can be made available to the interface 7, from which said variables can be transmitted to corresponding additional evaluation and/or monitoring and/or control systems 21 or switching devices arranged in between which are not shown here. In the case of the variables to be switched it can for example be a matter of one of the following named variables
variables which at least indirectly characterize the operational mode of the flexible coupling
variables which at least indirectly characterize a change of the operational and/or functioning mode of the flexible coupling
variables which at least indirectly characterize the mode of functioning and/or the state of the flexible coupling, in particular of the means 5 for spring and/or damping coupling.

Among others said variables include torques, speeds, and their modification behaviors over specified periods of time, torsional vibration variables.

In the case of designs with control device 19 classification and/or evaluation functions of the detected variables can be performed in the control device 19. For this purpose the control device 19 exhibits corresponding evaluation and/or comparison devices.

The evaluation and/or monitoring and/or control system 21 is in the process for example arranged in spatial distance to the interface 7 and with it to the flexible coupling. In the case of these it can, depending on the operating condition or field of application, be a matter of system a falling in the field of competence of the manufacturer of the flexible coupling or of the operator of the end application of the flexible coupling. On the basis of the preferred possibility of wireless data transmission that is employed it is possible to bridge considerable transmission paths, which is why no special requirements are to be made on the site of the evaluation and/or monitoring and/or control system 21. Preferably this is established at the manufacturer of the flexible coupling. However, it is also conceivable, depending on the application, to place theses systems with the service personnel of the end buyer, wherein the potential possibilities of remote data transmission can be optimally used.

With this configuration a great number of different tasks can be performed. For one thing it is possible to quickly and easily determine the variables characterizing at least indirectly the operational characteristics or the mode of functioning of the flexible coupling. The optimum realization then requires, depending on the application, a corresponding embodiment of the physical and logical connection, in particular for the structure of the transmission link from the interface 7 to the corresponding evaluation and/or monitoring and/or control system 21. In the simplest case this takes place by the removal of the device 6 for detecting at least one variable that is at least indirectly characteristic of the mode of operation of the flexible coupling and reading out of the variables at least indirectly characteristic of the mode of operation of the flexible coupling when required. In this case the device 6 for detecting at least one variable that is at least indirectly characteristic of the mode of operation of the flexible coupling corresponding to FIG. 2 is to be designed as a structural unit of sensor and transmission device 11. Otherwise a connection cannot take place continuously, but rather only corresponding to need, wherein the device 6 remains integrated in the flexible coupling 2. The connection can then be realized in various ways. Conceivable in the process is the establishment of the connection dependent on at least one variable at least indirectly characterizing the state of a necessary maintenance or diagnosis of components or independently from a required maintenance at any time.

In the first named case the initiation takes place in the case of the presence of at least one of the following named states:
a) The flexible coupling requires maintenance, for example after the expiration of a specified time interval t of the operating time
b) in the transmission of operational characteristics
c) detection of critical operating states of the flexible coupling beforehand through the changing of specified quantities characteristic of the mode of operation or functioning of the flexible coupling or individual components of said flexible coupling

In the second case an initiation of the connection is for example conceivable in the case of
d) intermittent querying of the mode of functioning of the flexible coupling by the manufacturer or service department entrusted with the maintenance.

The case described under a) can for example be characterized by one of the following named variables:
expiration of a predefined period of time t, which is defined as maintenance interval and which defines the distances between two maintenance passes
the presence of a variable that is at least indirectly characteristic of the mode of functioning and/or operation of the flexible coupling which lies outside of the normal range
severe change of the operational characteristics

Preferably however an initiation will be strived for in the case of problems in the mode of functioning or the detection of critical states of the flexible coupling. The other possibility lies in triggering the data transmission between the interface 7 and the evaluation and/or monitoring and/or controls system 21 only at the express desire of the manufacturer through the presence of a corresponding variable aiming at the establishment of the connection, for example of a corresponding call signal, for a telecommunications device. As already stated, the connection takes place between the evaluation and/or monitoring and/or control system 21 and the interface 7 via the transmission link preferably wirelessly or via a line connection. In the case of wireless data transmission the connection can for example be realized via a mobile telephone connection via GSM. In the case of this type of connection it is a matter of a transmission method switched by sound in which a transmission channel between the two subscribers is securely established. A further possibility for the execution of a wireless direct connection consists in the use of packet switched services, for example the so-called GPRS. In this case of said GPRS it is possible to distinguish between connection-oriented and connectionless data. In the case of the services supported by GPRS the following named services are distinguished:

a) Point-to-point services

b) Point-to-multipoint services.

Other designs are also possible.

If FIG. 1a illustrates the basic structure of a minimum configuration required in accordance with the invention and FIGS. 1b through 1e illustrate possibilities of detection and further processing of the data, FIG. 2 shows a particularly advantageous embodiment of a design in accordance with FIG. 1b. All designs preferably comprise an integrated power supply device 26.

By means of an axial section through a flexible coupling FIG. 2 illustrates the design of the device 6 for at least indirect detection of a variable at least indirectly characterizing the mode of operation of the flexible coupling 2 in accordance with FIG. 1b. The flexible coupling 2 here comprises a first coupling element 3 and at least one second coupling element 4, said elements being coupled to one another at least indirectly via means 5 for spring and/or damping coupling. The means 5 comprise in the represented case at least one flexible element, in particular an elastomer 22. The device 6 comprises here a support system 23 which is at least indirectly coupled in rotationally fixed manner to the flexible coupling 2. The arrangement takes place considered in axial direction in the region of the axial extension of the flexible coupling 2 and in the region of the rotational axis R. Preferably the arrangement of the means 15 for data acquisition, which in the represented case are designed in the shape of a rotary encoder 24, takes place coaxially to the rotational axis R, that is in axial direction on a plane with the axial extension of the flexible coupling 2. For this purpose said coupling encloses a hollow space in which the individual coupling elements 3 and 4 are designed as hollow shafts. The device 6 is then integrated in the hollow space. For this purpose said device can be designed as a centrifugal force sensor or an rpm sensor. This rotary encoder is coupled in rotationally fixed manner to the support system 23, while the support system 23 in turn is coupled in rotationally fixed manner to the flexible coupling 2. The coupling of the rotary encoder 24 to the support system 23 takes place in the represented case for example via a shaft coupling 25. Other designs are also conceivable. The shaft coupling 25 however facilitates an easy release and connection. Further a transmission device 11 is assigned to the rotary encoder 24. Said transmission device 11 is preferably arranged on the perimeter of the rotary encoder 24, that is eccentrically to the rotational axis R. In order to guarantee the operation of the transmission device 11 a power supply device 26 in the form of a rechargeable battery 27 is additionally provided, which is also arranged on the support system 23. The rechargeable battery 27 and transmission device 11 are constructed and designed in such a way that in the case of the device rotating synchronously the center of gravity of the device 6 still lies on the rotational axis of the coupling 2. The support element 23 in the process comprises a bell-shaped housing 28 which encloses the rotary encoder 24 as well as the power supply device 26 and the transmission device 11 in circumferential direction or fixes said rotary encoder 24, power supply device 26 and transmission device 11 with regard to their location. This applies additionally for the arrangement in axial direction.

The support system 23 comprises additionally a disk-shaped element 29 which is connected in rotationally fixed manner to the flexible coupling 2, in particular the means 5 for spring and/or damping coupling and the bell-shaped housing part 28. It is also conceivable to leave the bell-shaped housing part 28 stationary and only couple the sensor 24 to the rotating elements, wherein in this case the support system comprises one rotating and one resting component, which for example are connected to one another via a rotary transmission leadthrough.

The first coupling element 3 and the second coupling element 4 are twistable in limited extent with relation to one another in circumferential direction. Via the means 5 for spring and/or damping coupling for one thing torques are transferred and further torsional vibrations and deviations of position of the individual coupling elements 3, 4 are compensated from one another. In the represented case the rotational fixing of the device 6 takes place via fastening elements, for example only schematically reproduced via screw connections to the means 5 for spring and or damping coupling 5 as well as the second coupling element 4.

FIG. 3 illustrates on the other hand a further development in accordance with FIG. 2. In said figure the device for detecting at least two variables that are at least indirectly characteristic of the mode of operation of the flexible coupling is designed as a control device 19. Said control device comprises the means for data acquisition 15 as well as a memory unit 18 and an interface 7, via which the reading out of the data takes place. In this case the entire device can be integrated into the support system 23 and can be removed by the removal of said support system from the flexible coupling 2.

### REFERENCE LIST

1 System for determining operational characteristics
2 Flexible coupling
3 First coupling element
4 Second coupling element
5 Means for spring and/or damping coupling
6 Device for detecting at least one variable that is at least indirectly characteristic of the mode of operation of the flexible coupling
7 Interface
8 Means for reading out the variables that are at least indirectly characteristic of the mode of operation of the flexible coupling
9 Means for data transmission
10 Means for wireless data transmission
11 Transmission device
12 External transmission device
13 Receiving device
14 Telecommunications device
15 Means for data acquisition
16 Connecting device
17 External readout device
18 Memory unit
19 Control device
20 Means for serial data transmission
21 Monitoring and/or control system
22 Flexible element
23 Support system
24 Rotary encoder
25 Shaft coupling
26 Power supply device
27 Rechargeable batter
28 Bell-shaped housing
29 Disk-shaped element
30 Sensor
31 Sensor
32 Readout device

1. A torsional vibration damper with a flexible coupling, comprising at least one first coupling element which can be connected to a driving element, a second coupling element which can be connected to a power take-off in rotationally fixed manner, said elements being at least indirectly coupled to each other via spring or damping coupling means;
with a device for detecting at least one variable that is at least indirectly characteristic of the mode of operation of the flexible coupling;
characterized by the following features:
the device for detecting at least one variable that is at least indirectly characteristic of the mode of operation of the flexible coupling is completely integrated in the flexible coupling;
the device for detecting at least one variable that is at least indirectly characteristic of the mode of operation of the flexible coupling comprises means for acquiring the operational characteristics and a permanently mounted interfaces, comprising means for reading out the variables that are at least indirectly characteristic of the mode of operation of the flexible coupling.

2. The torsional vibration damper according to claim 1, characterized in that the means for acquiring the operational characteristics are arranged coaxially to the rotational axis of the flexible coupling.

3. The torsional vibration damper according to claim 2, characterized in that the means for acquiring the data are arranged on the rotational axis of the flexible coupling.

4. The torsional vibration damper according to claim 1, characterized in that the means for acquiring the operational characteristics comprise a sensor.

5. The torsional vibration damper according to claim 4, characterized in that the means for acquiring the operational characteristics comprise an rpm sensor.

6. The torsional vibration damper according to claim 4, characterized in that the means for acquiring the operational characteristics comprise a centrifugal force sensor.

7. The torsional vibration damper according to claim 1, characterized in that the device exhibits a support system in which the means for acquiring the data or the variable at least indirectly characteristic of the mode of operation of the flexible coupling are integrated and which is connected in rotationally fixed manner to the means for spring and/or damping coupling and one of the coupling elements—the first or second coupling element.

8. The torsional vibration damper according to claim 7, characterized in that the support system exhibits a bell-shaped housing part which encloses the means for acquiring the variables at least indirectly characteristic of the mode of operation of the flexible coupling and are supported on said support system and a disk-shaped element which couples the bell-shaped housing part to the flexible coupling, in particular one of the two coupling elements.

9. The torsional vibration damper according to claim 1, characterized in that the means for reading out the variables that are at least indirectly characteristic of the mode of operation of the flexible coupling comprise a connecting device for the coupling of external readout devices.

10. The torsional vibration damper according to claim 1, characterized in that the device for detecting at least one variable that is at least indirectly characteristic of the mode of operation of the flexible coupling comprises means for data transmission.

11. The torsional vibration damper according to claim 10, characterized in that the means for data transmission are a component of the interface.

12. The torsional vibration damper according to claim 10, characterized in that the means for data transmission are designed as means for wireless data transmission.

13. The torsional vibration damper according to claim 10, characterized in that the means for wireless data transmission comprise at least one transmission device.

14. The torsional vibration damper according to claim 12, characterized in that the means for wireless data transmission comprise at least one receiving device.

15. The torsional vibration damper according to claim 12, characterized in that the means for wireless data transmission are formed by a radio telecommunications device.

16. The torsional vibration damper according to claim 12, characterized in that the transmission and/or receiving device is designed for the processing and/or transmission of ultrasound signals.

17. The torsional vibration damper according to claim 12, characterized in that the transmission and/or receiving device is designed for the processing and/or transmission of infrared signals.

18. The torsional vibration damper according to claim 12, characterized in that the transmission and/or receiving devices are integrated in the flexible coupling.

19. The torsional vibration damper according to claim 18 characterized in that the transmission and/or receiving device is arranged coaxially or eccentrically to the rotational axis of the flexible coupling.

20. The torsional vibration damper according to claim 1, characterized in that the device comprises a memory device for storage of the operational characteristics.

21. The torsional vibration damper according to claim 20 characterized in that the interface is a component of the memory device.

22. The torsional vibration damper according to claim 1, characterized in that the device comprises a control device which is connected to the means for data acquisition wirelessly or via line connections.

23. The torsional vibration damper according to claim 22 characterized in that the interface is a component of the control device.

24. The torsional vibration damper according to claim 22, characterized in that the control device comprises at least one of the following named devices:
a classification device
a comparison device
memory device

25. The torsional vibration damper according to claim 1 characterized in that the device comprises a power supply device for supplying power to the individual components.

26. The torsional vibration damper according to claim 1 characterized in that the individual components of the device are arranged to one another in such a way that the center of gravity lies on the rotational axis.

27. The torsional vibration damper according to claim 22, characterized in that the control device is annular in design and encloses the means for data acquisition.

28. The torsional vibration damper according to claim 1, characterized in that the device can be connected to an external monitoring and/or control system via the interface.
